(19) United States
(12) Patent Application Publication
(10) Pub. No.: US 2010/0014939 A1
(43) Pub. Date: Jan. 21, 2010

(54) FASTENER

(75) Inventors: LUNG-SHENG TSAI, Tu-Cheng (TW); HO-CHIN TSAI, Tu-Cheng (TW); CHIA-KANG WU, Tu-Cheng (TW); LI-PING CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/468,953

(22) Filed: May 20, 2009

(30) Foreign Application Priority Data
Jul. 16, 2008 (CN) 200820301527.8

(51) Int. Cl. F16B 21/18

(52) U.S. Cl. 411/352

(57) ABSTRACT

A fastener is provided. The fastener includes a ferrule, a head, a shaft, and a spring member. The ferrule includes a first end and a second end, and a hollow bore. The head is adjacent the first end of the ferrule. The shaft extending through the hollow bore of the ferrule from the second end of the ferrule to securely engage with the head. The spring member is retained in the ferrule to drive the shaft to extend out of the second end of the ferrule when the spring is in a normal state, and to retract in the ferrule from the second end of the ferrule when the spring is in a compressed state.

### BACKGROUND

1. Technical Field

The present disclosure relates to a fastener for attaching a first component to a second component.

2. Description of Related Art

To secure a first component to a second component, fasteners are usually used. For example, in assembly of a panel to a computer enclosure, a screwdriver and screws are generally used, which is laborious and time-consuming. Furthermore, unintentional accidents, for example operator dropping tools and screws, may occur during operations. When this happens, other internal components of the computer are liable to be damaged.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of one embodiment of a first component, a second component, and a fastener configured to secure the first component to the second component.

FIG. 2 is an exploded, isometric view of one embodiment of the fastener of FIG. 1.

FIG. 3 is an assembly view of FIG. 2.

FIG. 4 is an assembly, cutaway view of FIG. 1.

FIG. 5 is similar to FIG. 4, but showing the fastener released from the second component.

### DETAILED DESCRIPTION

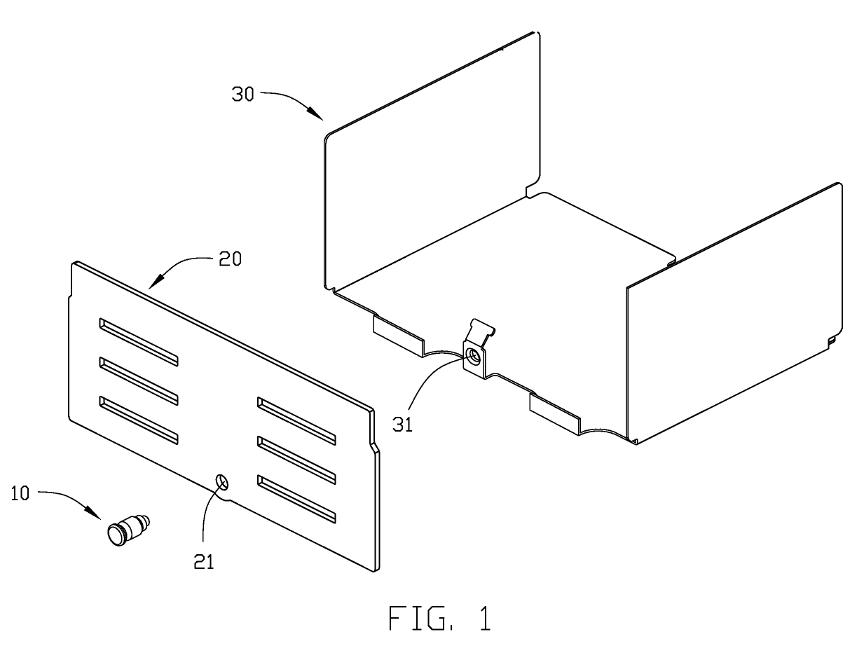

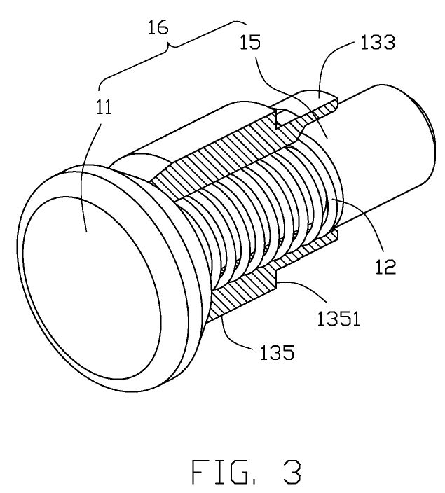

Referring to FIG. 1, a fastener 10 is provided to attach a first component to a second component. In the present embodiment, the first component is a panel 20, and the second component is a bracket 30. The panel 20 defines a mounting hole 21 corresponding to the fastener 10. The bracket 30 defines a securing hole 31 corresponding to the mounting hole 21. One embodiment of the fastener 10 includes a ferrule 13 and a positioning member 16 (shown in FIG. 3).

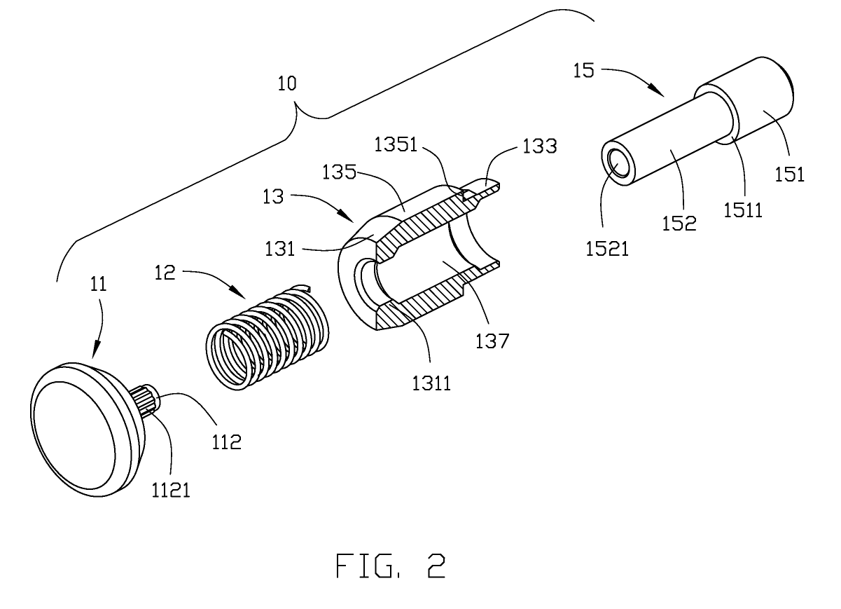

Referring to FIG. 2, the ferrule 13 of the fastener 10 includes a first end 131, a second end 133, and a peripheral wall 135 connecting the first end 131 to the second end 133. A bore 137 is defined through the first end 131, the peripheral wall 135, and the second end 133. The peripheral wall 135 and the second end 133 are cylindrical. An external diameter of the second end 133 is a less than that of the mounting hole 21 such that the second end 133 may extend through the mounting hole 21. The second end 133 is not as thick as the peripheral wall 135 so as to be deformable and engaged with the panel 20. And, an external diameter of the peripheral wall 135 is greater than that of the mounting hole 21 so that a bottom surface 1351 of the peripheral wall 135 may abut on the panel 20 to prevent the ferrule 13 from disengaging the mounting hole 21. The first end 131 of the ferrule 13 has an annular blocking flange 1311 projected from the peripheral wall 135 inward toward the central longitudinal axis of the ferrule 13. The internal diameter of the blocking portion 1311 is less than the diameter of the peripheral wall 135.

The positioning member 16 includes a head 11 and a shaft 15 securely engaging with the head 11. The head 11 is located outside the first end 131 of the ferrule 13 and can be accessed by a user for pushing or pulling. A securing post 112 protrudes from the center of the head 11. The shaft 15 includes a cylinder pole 152 and a cylinder engaging end 151 connected to the pole 152. The pole 152 and the engaging end 151 have a common center. An external diameter of the engaging end 151 is greater than that of the pole 152. An annular supporting flange 1511 is defined on a surface of the engaging end 151 where the pole 152 is joined to the engaging end 151. The pole 152 defines a securing hole 1521 in a longitudinal axis direction of the pole 152 for the securing post 112 of the head 11 engaging therein. A grooved portion 1121, located on the peripheral surface of the securing post 112, has a periphery that is greater than the internal diameter of the securing hole 1521. The securing post 112 tightly engages in the securing hole 1521. In other embodiments, the securing post 112 may engage in the securing hole 1521 by other known means.

Referring also to FIG. 3, in assembly of the fastener 10, a spring member 12 is fit about the pole 152 of the shaft 15. The shaft 15 extends through the hollow bore 137 from the second end 133 of the ferrule 13. The securing post 112 is inserted into the securing hole 1521. The grooved portion 1121 is tightly engaged in the securing hole 1521. Thus, the positioning member 16 is assembled with the ferrule 15 to form the fastener 10. The spring member 12 is retained in the ferrule 13 with one end of the spring member 12 abutting on the annular supporting flange 1511, and the other end is blocked by the annular blocking flange 1311 of the ferrule 13.

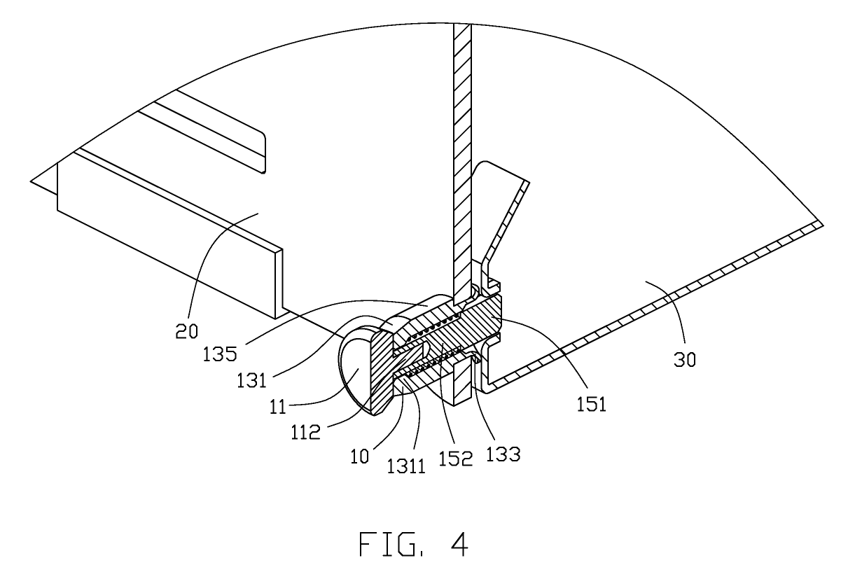

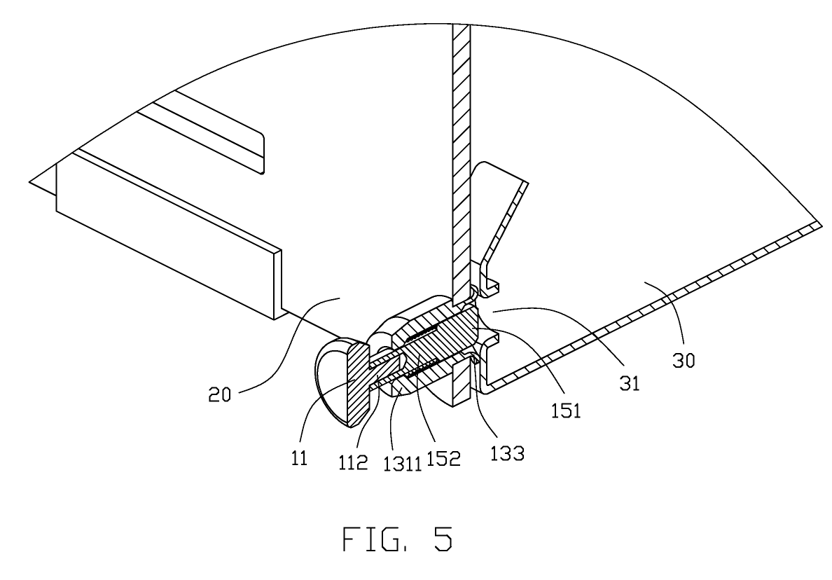

Referring also to FIGS. 4 and 5, in assembling the fastener 10 to the panel 20, the second end 133 of the ferrule 10 extends through the mounting hole 21 of the panel 20. The bottom surface of the peripheral wall 133 of the ferrule 13 abuts the panel 20. The second end 133 is expanded and bent radially by stamping technology or other similar technologies, thus being secured to a periphery of the mounting hole 21 of the panel 20. The panel 20 is sandwiched between the peripheral wall 133 and the second end 133 of the ferrule 10. Thus, the fastener 10 is securely mounted to the panel 20.

In mounting the panel 20 to the bracket 30, the head 11 of the positioning member 16 is pulled outward away from the first end 131 of the ferrule 13. The engaging end 151 of the shaft 15 is retracted into the hollow bore 137 of the ferrule 13. The spring member 12 is compressed by the supporting flange 1511 of the shaft 15 as the engaging end 151 moves toward the blocking flange 1311 of the ferrule 10, storing elastic force. Then, the bore 137 of the ferrule 10 is aligned with the securing hole 31 of the bracket 30. The head 11 of the positioning member 16 is released. The spring 12 member rebounds back to a normal state. The engaging end 151 of the shaft 15 is forced by the spring member 12 to extend out from the second end 133 of the ferrule 13 and engage in the securing hole 31 of the bracket 30, thus attaching the panel 20 to the bracket 30.

In disassembling the panel 20 from the bracket 30, the head 11 of the positioning member 16 is pulled outward away from the first end 131 of the ferrule 13. The engaging end 151 of the shaft 15 is retracted into the hollow bore 137 of the ferrule 13 from the securing hole 31 of the bracket 31. Thus, the panel 20 may be removed away from the bracket 30.

It is to be understood, however, that even though numerous characteristics and advantages of the embodiments have been set forth in the foregoing description, together with details of the structure and function of the present disclosure, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A fastener, comprising:
a ferrule having a first end and a second end, a bore defined in the ferrule;
a head adjacent the first end;
a shaft extending through the bore of the ferrule to securely engage with the head; and
a spring member being retained in the ferrule biasing the shaft to extend out of the second end.

2. The fastener of claim 1, wherein the ferrule comprises a peripheral wall connecting the first end to the second end, and the first end comprises a blocking edge having a internal diameter less than the internal diameter of the peripheral wall; the shaft comprises an engaging end opposite to the head, the spring member is retained between the blocking portion and the engaging end.

3. The fastener of claim 2, wherein the second end has an external diameter less than the peripheral wall.

4. The fastener of claim 2, wherein the shaft comprises a pole connected with the engaging end, the pole defines a securing hole, the head comprises a securing post engaging in the securing hole.

5. The fastener of claim 4, wherein a grooved portion is provided on a peripheral surface of the securing post, the grooved portion has a periphery that is greater than the securing hole diameter.

6. The fastener of claim 4, wherein both the pole and the engaging end are cylindrical and coaxial, an external diameter of the engaging end is greater than that of the pole; the spring member is fit about the pole of the shaft, and one end of the spring member abuts on an annular edge of the engaging end.

7. A system, the system comprising:
a first component, the first component having a mounting hole;
a second component having a securing hole;
a fastener comprising:
a ferrule comprising a first end, a second end, and a bore; the second end engages the mounting hole to attach the ferrule to the first component, the first end having a blocking portion that protrudes into the bore;
a head located outside the first end of the ferrule;
a shaft extending through the bore of the ferrule and engaging with the head, the shaft having an engaging end opposite to the head; and
a spring member being retained in the ferrule between the blocking portion of the ferrule and the engaging end, biasing the engaging end of the shaft to extend in the securing hole of the second component.

8. The system of claim 7, wherein the ferrule comprises a peripheral wall connecting the first end to the second end, the blocking portion has an internal diameter less than an internal diameter of the peripheral wall.

9. The system of claim 8, wherein the second end of the ferrule has an external diameter less than an external diameter of the ferrule so that a bottom surface of the peripheral wall abuts the first component as the second end extends through the mounting hole.

10. The system of claim 8, wherein the shaft comprises a pole connected with the engaging end, the pole defines a securing hole, the head comprises a securing post engaging in the securing hole.

11. The system of claim 10, wherein a grooved portion is provided on a peripheral surface of the securing post, the grooved portion has a periphery that is greater than a diameter of the securing hole to tightly engaging in the securing hole.

12. The system of claim 10, wherein both the pole and the engaging end of the shaft are cylindrical and coaxial, an external diameter of the engaging end is greater than that of the pole, the spring member is fit about the pole, and one end of the spring member abuts on an annular supporting edge of the engaging end.

13. The system of claim 7, wherein the second end of the ferrule has an expanded and radially bent portion that secures the ferrule to a periphery of the first component mounting hole.

14. A fastener for securing a first component to a second component, the first component having a mounting hole, the fastener comprising:
a ferrule comprising a first end, a second end, and a bore, the second end being adapted for engaging in the mounting hole of the first component, the first end of the ferrule having a blocking portion that protrudes into the bore;
a positioning member received in the bore of the ferrule, the positioning member having an engaging end adapted to extend through the first component the mounting hole; and
a spring being retained in the ferrule between the ferrule blocking portion and the positioning member engaging end to bias the engaging end of the positioning member to extend out of the second end of the ferrule.

15. The fastener of claim 14, wherein the positioning member comprises a shaft and a head located outside the ferrule first end, the shaft extends through the ferrule bore and securely engaging with the head, the engaging end is formed on the shaft opposite to the head.
